(19) United States
(12) Patent Application Publication
(10) Pub. No.: US 2018/0353892 A1
(43) Pub. Date: Dec. 13, 2018

(54) HONEYCOMB BODY THERMAL BARRIER, EXHAUST GAS TREATMENT ARTICLE, EXHAUST SYSTEM, AND METHODS OF MANUFACTURING SAME

(71) Applicant: Corning Incorporated, Corning, NY (US)

(72) Inventors: Dana Craig Bookbinder, Corning, NY (US); Pushkar Tandon, Painted Post, NY (US); Christopher John Warren, Waverly, NY (US)

(21) Appl. No.: 15/777,053

(22) PCT Filed: Nov. 22, 2016
(86) PCT No.: PCT/US2016/063229

§ 371 Date: May 17, 2018

Related U.S. Application Data
(60) Provisional application No. 62/259,778, filed on Nov. 25, 2015.

(51) Int. Cl. B01D 46/24; F01N 3/021; F01N 3/28

(52) U.S. Cl. CPC B01D 46/2422; B01D 46/2444; B01D 46/2459; F01N 3/0211; F01N 2350/06; F01N 3/2842; F01N 3/2878; F01N 2330/60; F01N 3/2828

(57) ABSTRACT

An exhaust system includes an exhaust gas treatment article having a porous ceramic honeycomb body mounted in a housing. The exhaust gas treatment article includes a thermal barrier disposed at the outer peripheral surface of the honeycomb body, wherein the thermal barrier comprises blocked peripheral cell channels adjacent to and around the entire peripheral surface and/or a thermal barrier skin.

### CROSS-REFERENCE TO RELATED APPLICATIONS

This application claims the benefit of priority of U.S. Provisional Application Ser. No. 62/259,778 filed on Nov. 25, 2015 the content of which is relied upon and incorporated herein by reference in its entirety.

### BACKGROUND

### Field

Exemplary embodiments of the present disclosure relate to a honeycomb body thermal barrier, an exhaust gas treatment article comprised thereof, an exhaust system comprised thereof, and methods of manufacturing the same and, more particularly, to a honeycomb body comprising a thermal barrier, an exhaust gas treatment article comprising the honeycomb body disposed in a housing, an exhaust system comprising the exhaust gas treatment article, and methods of manufacturing the same.

### Discussion of the Background

After-treatment of exhaust gas from internal combustion engines may use catalysts supported on high-surface area substrates and, in the case of diesel engines and some gasoline direct injection engines, a catalyzed or non-catalyzed filter for the removal of carbon soot particles. Porous ceramic flow-through honeycomb substrates and wall-flow honeycomb filters may be used in these applications.

The above information disclosed in this Background section is only for enhancement of understanding of the background of the disclosure and therefore it may contain information that does not form any part of the prior art nor what the prior art may suggest to a person of ordinary skill in the art.

### SUMMARY

Exemplary embodiments of the present disclosure provide a honeycomb body having a thermal barrier.

Exemplary embodiments of the present disclosure also provide an exhaust gas treatment article having the honeycomb body with the thermal barrier.

Exemplary embodiments of the present disclosure also provide an exhaust system.

Exemplary embodiments of the present disclosure also provide a method of manufacturing an exhaust gas treatment article.

Additional features of the disclosure will be set forth in the description which follows, and in part will be apparent from the description, or may be learned by practice of the disclosure.

An exemplary embodiment discloses a honeycomb body having a thermal barrier. The honeycomb body comprises a plurality of porous ceramic channel walls extending axially from opposing first and second end faces defining cell channels therebetween, an outer peripheral surface extending axially, and a thermal barrier disposed at the outer peripheral surface.

An exemplary embodiment also discloses an exhaust gas treatment article. The exhaust gas treatment article comprises a honeycomb body and a housing configured to mount the honeycomb body. The honeycomb body comprises a porous ceramic having a plurality of channel walls extending axially from opposing first and second end faces defining cell channels therebetween, and an outer peripheral surface extending axially, and a thermal barrier disposed at the outer peripheral surface. The thermal barrier comprises at least one of blocked peripheral cell channels adjacent to and around the peripheral surface and a thermal barrier skin, wherein an inner surface of the housing is in direct contact with the honeycomb body.

An exemplary embodiment also discloses an exhaust system. The exhaust system comprises an inlet configured to accept an exhaust gas stream to be purified, an exhaust gas treatment article configured to flow the exhaust gas stream through a honeycomb body to purify the exhaust gas stream, and an outlet configured to emit the purified exhaust gas stream. The exhaust gas treatment article comprises a honeycomb body and a housing configured to mount the honeycomb body. The honeycomb body comprises a porous ceramic having a plurality of channel walls extending axially from opposing first and second end faces defining cell channels therebetween, and an outer peripheral surface extending axially, and a thermal barrier disposed at the outer peripheral surface. The thermal barrier comprises at least one of blocked peripheral cell channels adjacent to and around the peripheral surface and a thermal barrier skin, wherein an inner surface of the housing is in direct contact with the honeycomb body.

An exemplary embodiment also discloses a method of manufacturing an exhaust gas treatment article. The method comprises mounting the honeycomb body in the housing configured to hold the honeycomb body in an exhaust gas stream. The mounting comprises disposing the honeycomb body in an inner space defined by an inner surface of the housing, wherein the honeycomb body comprises a thermal barrier disposed at the outer peripheral surface, wherein the thermal barrier comprises at least one of blocked peripheral cell channels adjacent to and around the peripheral surface and a thermal barrier skin, and wherein an inner surface of the housing is in direct contact with the honeycomb body.

Additional features of the disclosure will be set forth in the description which follows, and in part will be apparent from the description, or may be learned by practice of the disclosure. It is to be understood that both the foregoing general description and the following detailed description are exemplary and explanatory and are intended to provide further explanation of the disclosure.

### BRIEF DESCRIPTION OF THE FIGURES

The accompanying drawings, which are included to provide a further understanding of the disclosure and are incorporated in and constitute a part of this specification, illustrate exemplary embodiments of the disclosure, and together with the description serve to explain the principles of the disclosure.

FIG. 1 presents a schematic cross sectional view of a conventional arrangement of a honeycomb body canned with a mat.

FIG. 2A presents a schematic cross sectional view of a honeycomb body disposed in a housing without a mat, in which outer channels of the honeycomb body are plugged around the entire periphery to provide a thermal barrier between the honeycomb body and the housing according to exemplary embodiments of the disclosure. FIG. 2B presents a schematic end view of a honeycomb body disposed in a housing without a mat, in which outer channels of the honeycomb body are plugged around the entire periphery to provide a thermal barrier between the honeycomb body and the housing according to exemplary embodiments of the disclosure.

FIG. 3 presents a schematic cross sectional view of a honeycomb body disposed in a housing without a mat, in which a skin of the honeycomb body around the entire periphery provides a thermal barrier between the honeycomb body and the housing according to exemplary embodiments of the disclosure.

FIG. 4 presents a schematic cross sectional view of a honeycomb body disposed in a housing without a mat, in which a housing component blocks channels of the honeycomb body around the entire periphery to provide a thermal barrier between the honeycomb body and the housing according to exemplary embodiments of the disclosure.

FIG. 5 presents a schematic end view of a honeycomb body disposed in a housing without a mat, in which outer channels of the honeycomb body are plugged around the entire periphery to provide a thermal barrier between the honeycomb body and the housing according to exemplary embodiments of the disclosure.

FIG. 6 presents a schematic of an exhaust system comprising a honeycomb body disposed in a housing without a mat, wherein the outer channels of the honeycomb body are blocked around the entire periphery and/or a thermal barrier skin is disposed on the honeycomb body around the entire periphery thereby providing a thermal barrier between the honeycomb body and the housing according to exemplary embodiments of the disclosure.

FIG. 7 is a graphical plot of experimental data showing the metal housing temperature for samples prepared according to exemplary embodiments of the disclosure.

### DETAILED DESCRIPTION

The disclosure is described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these embodiments are provided so that this disclosure is thorough, and will fully convey the scope of the disclosure to those skilled in the art. In the drawings, the size and relative sizes of layers and regions may be exaggerated for clarity.

It will be understood that when an element or layer is referred to as being “on”, “connected to”, or “adjacent to” another element or layer, it can be directly on, directly connected to, or directly adjacent to the other element or layer, or intervening elements or layers may be present. In contrast, when an element or layer is referred to as being “directly on”, “directly connected to”, or “directly adjacent to” another element or layer, there are no intervening elements or layers present. Like reference numerals in the drawings denote like elements. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

While terms such as, top, bottom, side, upper, lower, vertical, and horizontal are used, the disclosure is not so limited to these exemplary embodiments. Instead, spatially relative terms, such as “top”, “bottom”, “horizontal”, “vertical”, “side”, “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” modifying, for example, the quantity of an ingredient in a composition, concentrations, volumes, process temperature, process time, yields, flow rates, pressures, viscosities, and like values, and ranges thereof, employed in describing the embodiments of the disclosure, refers to variation in the numerical quantity that can occur, for example: through typical measuring and handling procedures used for preparing materials, compositions, composites, concentrates, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

In these exemplary embodiments, the disclosed article, and the disclosed method of making the article provide one or more advantageous features or aspects, including for example as discussed below. Features or aspects recited in any of the claims are generally applicable to all facets of the disclosure. Any recited single or multiple feature or aspect in any one claim can be combined or permuted with any other recited feature or aspect in any other claim or claims.

Exemplary embodiments of the disclosure relate to an improved exhaust gas treatment article including a honeycomb body mounted in a metal housing, as well as an economical and efficient method for mounting a honeycomb body in a metal housing. The exhaust gas treatment article may be part of an exhaust gas treatment system (exhaust system) to clean exhaust gases.

Auto, truck, motorcycle, other mobile, as well as stationary, catalytic converter honeycomb substrates and diesel filters (honeycomb bodies) can be mounted inside housings (cans). For ease of description, the exemplary embodiments refer to honeycomb body, but the disclosure is not so limited, that is trough filters and radial flow filters are intended to be included in this disclosure. A fiber mat can be placed around the honeycomb body to minimize the effects of vibration and movement. As the honeycomb body and housing become hot and the metal housing expands in diameter and length, the mat acts as a buffer, taking up the additional space, thus protecting the honeycomb body from movement.

During long-term usage, temperature cycling and vibration can break down the integrity of the mat. Some mats are an expensive component in the exhaust system and can cost a customer almost as much as the honeycomb body. There are also potential problems of the mat decomposing and fibers from the mat plugging downstream parts of the exhaust system. Furthermore, the placement of the mat during canning processes can lead to manufacturing complications and inefficiencies.

The manufacture of porous ceramic honeycomb bodies may be accomplished by the process of plasticizing ceramic powder batch mixtures, extruding the mixtures through honeycomb extrusion dies to form honeycomb extrudate, and cutting, drying, and firing the extrudate to produce ceramic honeycomb bodies of high strength and thermal durability having channels extending axially from a first end face to a second end face. As used herein a ceramic honeycomb body includes ceramic honeycomb monoliths and ceramic segmented honeycomb bodies.

A co-extruded or an after-applied exterior skin may form an outer peripheral surface extending axially from a first end face to a second end face of the ceramic honeycomb body. Each channel of the honeycomb body defined by intersecting walls (webs), whether monolithic or segmented, can be plugged at an inlet face or an outlet face to produce a filter. When some channels are left unplugged a partial filter can be produced. The honeycomb body, whether monolithic or segmented, can be catalyzed to produce a substrate. A non-plugged honeycomb body is generally referred to herein as a substrate. The catalyzed substrate can have an after applied catalyst or comprise an extruded catalyst. Further, filters and partial filters can be catalyzed to provide multi-functionality. The ceramic honeycomb bodies thus produced are widely used as catalyst supports, membrane supports, as wall-flow filters, as partial filters, and as combinations thereof for cleaning fluids such as purifying engine exhausts.

Ceramic honeycomb body compositions are not particularly limited and can comprise major and minor amounts of cordierite, aluminum-titanate, mullite, β-spodumene, silicon carbide, zeolite and the like, and combinations thereof. As a further example, the ceramic honeycomb body can comprise an extruded zeolite or other extruded catalyst.

Ceramic honeycomb bodies may be disposed in a housing (can) in an exhaust system. The housing may be referred to as a can and the process of disposing the ceramic honeycomb body in the can may be referred to as canning. A ceramic honeycomb body disposed in a can may be referred to as canned.

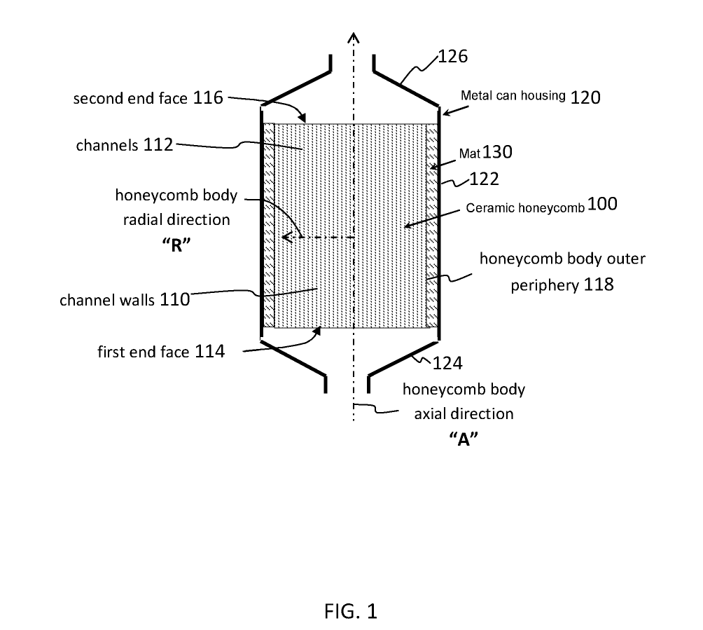

FIG. 1 shows a schematic cross sectional view of a conventional arrangement of a honeycomb body canned with a mat. The honeycomb body 100 includes a core 102 and a peripheral region 104 surrounding the core 102. The honeycomb body 100 includes a plurality of intersecting walls 110 that form mutually adjoining cell channels 112 extending axially between opposing end faces 114, 116. The top face 114 refers to the first end face and the bottom face 116 refers to the second end face of the honeycomb body 100 positioned in FIG. 1, otherwise the end faces are not limited by the orientation of the honeycomb body 100. The top face 114 may be an inlet face and the bottom face 116 may be an outlet face of the honeycomb body 100 or the top face 114 may be an outlet face and the bottom face 116 may be an inlet face of the honeycomb body 100. The outer peripheral surface 118 of the honeycomb body 100 extends axially from the first end face 114 to the second end face 116.

Cell density can be between about 100 and 900 cells per square inch (cpsi). Typical cell wall thicknesses can range from about 0.025 mm to about 1.5 mm (about 1 to 60 mil). For example, honeycomb body 100 geometries may be 400 cpsi with a wall thickness of about 8 mil (400/8) or with a wall thickness of about 6 mil (400/6). Other geometries include, for example, 100/17, 200/12, 200/19, 270/19, 600/4, 400/4, 600/3, and 900/2. As used herein, honeycomb body 100 is intended to include a generally honeycomb structure but is not strictly limited to a square structure. For example, hexagonal, octagonal, triangular, rectangular or any other suitable cell shape may be used. Also, while the cross section of the cellular honeycomb body 100 is circular, it is not so limited, for example, the cross section can be elliptical, square, rectangular, or other desired shape, and a combination thereof.

The housing (can) 120 includes an axial section 122 covering the outer peripheral surface 118 of the honeycomb body 100 and funnel-shaped first and second cones 124, 126 that may correspond to inlet and outlet of the exhaust gas treatment article. The housing 120 is generally fabricated of metal or other material that is impermeable to gases, and is configured to contain one or more honeycomb bodies 100. For example, the housing can comprise aluminum, stainless steel such as 400-series stainless steel or 300-series stainless steel, titanium alloy, titanium, and the like. The housing wall thickness can be from 300 micron to 3 mm. Exhaust gases flow through the honeycomb body 100 in the general axial direction as indicated by arrow “A”, including through the channels 112 that may or may not be catalyzed, and in the case of filters, through the channel walls 110. A mat 130 can be placed around the honeycomb body 100 to minimize the effects of vibration and movement.

Heat shielding the honeycomb body 100 core from the metal housing 120 is one of the functions of the mat 130. The honeycomb body 100 core is the bulk of the honeycomb body up to a peripheral region of the honeycomb body 100. According to exemplary embodiments of the disclosure, heat shielding the honeycomb body 100 core from the metal housing 120 can be achieved without a mat 130 by at least one of blocking the outer cells of the honeycomb body 100 in the peripheral region via a mounting ring of the housing 120 and/or plugging cement, and a thick skin disposed on the honeycomb body outer periphery 118.

Examples of a honeycomb body mounted in a housing without a mat are provided in U.S. Provisional Patent Application having Ser. No. 62/136,917, titled Exhaust Gas Treatment Article and Methods of Manufacturing Same, filed on Mar. 23, 2015, U.S. Provisional Patent Application having Ser. No. 62/158,813, titled Housing, Fluid Stream Treatment Article, Exhaust System and Methods of Manufacturing Same, filed on May 8, 2015, and U.S. Provisional Patent Application having Ser. No. 62/132,569, titled Honeycomb Assembly and Packaging System, filed on Mar. 13, 2015, all of which are hereby incorporated by reference in their entireties as if fully set forth herein.

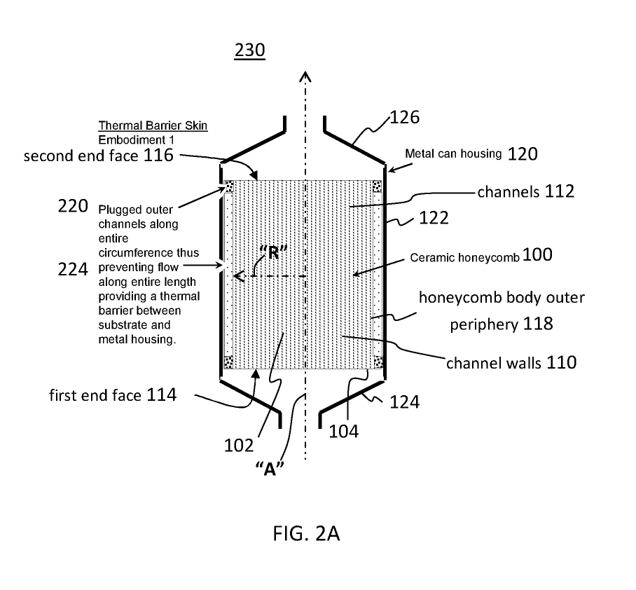

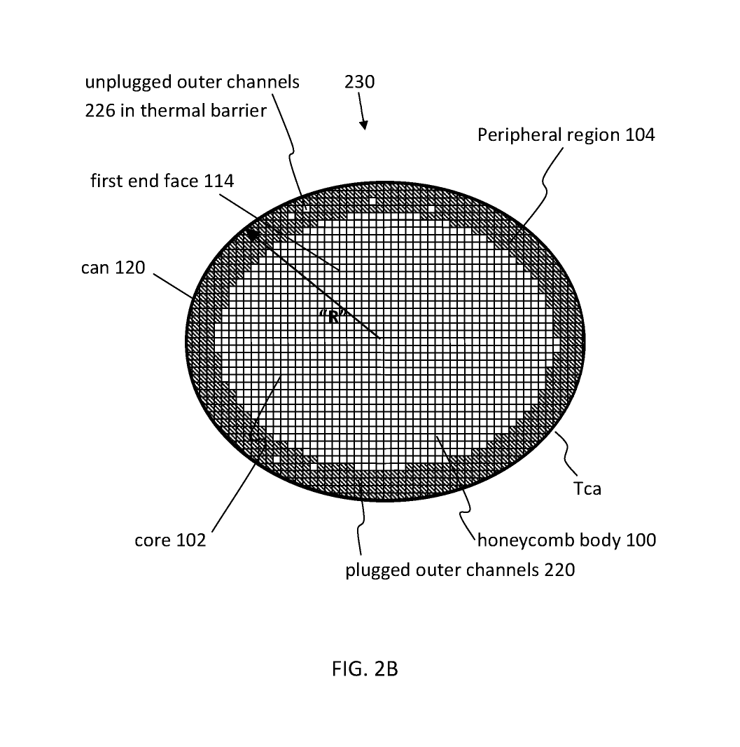

FIG. 2A presents a schematic cross sectional view of a honeycomb body disposed in a housing without a mat, in which outer channels of the honeycomb body are plugged around the entire periphery to provide a thermal barrier between the honeycomb body and the housing according to exemplary embodiments of the disclosure. FIG. 2B presents a schematic end view of a honeycomb body disposed in a housing without a mat, in which outer channels of the honeycomb body are plugged around the entire periphery to provide a thermal barrier between the honeycomb body and the housing according to exemplary embodiments of the disclosure. Plugs 220 can be formed with plugging cement at both the first end face 114 and at the second end face 116 to define thermal barrier channels 224. Plugs 220 can be formed with plugging cement at either the first end face 114 or at the second end face 116 to define thermal barrier channels 224. Further, Plugs 220 can be formed with plugging cement along the length of the channels 112 from the first end face 114 toward the second end face 116 to define thermal barrier channels 224, including, for example, from the first end face 114 to the second end face 116. Heat shielding the honeycomb body 100 core from the metal housing 120 can be achieved by the thermal barrier channels 224 in the peripheral region 104 of the honeycomb body 100. Thermal barrier channels 224 can include channels and partial channels at the honeycomb body outer periphery 118 and channels adjacent thereto extending from two to 30 channels inward along a radial direction toward the center region of the honeycomb body 100. For example, the outer 20 channels 112 of the honeycomb body 100 at the outer periphery 118 can be thermal barrier channels 224, the outer 10 channels 112 of the honeycomb body 100 at the outer periphery 118 can be thermal barrier channels 224, the outer 4 channels 112 of the honeycomb body 100 at the outer periphery 118 can be thermal barrier channels 224, or even the outer 2 channels 112 of the honeycomb body 100 at the outer periphery 118 can be thermal barrier channels 224. The number of channels 112 that form the thermal barrier channels 224 can vary depending on the honeycomb body 100 cell density. The thermal barrier thickness can be greater than 2 mm, for example, greater than 5 mm thick, greater than 7 mm thick, greater than 10 mm or even greater than 20 mm thick. For example, the thermal barrier can be from about 2 mm to about 25 mm thick, 3 mm to 20 mm thick, or about 5 mm to about 17 mm thick. The terms radial, around, and circumferential are used herein to describe relative directions, and are not intended to limit the cross sectional shape of the honeycomb body 100. For example, a relative direction toward the center of a square, circle, ellipse, etc. is understood to refer to an inward radial direction. For example, the perimeter of a square, circle, ellipse, etc. will be understood to refer to around the periphery of the square, circle, ellipse, etc.

As shown in FIG. 2B, there may be some unplugged channels 226 within the region of the thermal barrier channels 224 of the thermal barrier according to exemplary embodiments of the disclosure. An unplugged channel 224 referred to herein has no obstruction blocking flow from the first end face 114 to the second end face 116. When a small percentage of channels 112 are unplugged channels 226 within the region of the thermal barrier channels 224, the thermal insulation effect is not substantially adversely affected. For example, when as much as 10% of the channels 112 within the region of the thermal barrier channels 224 are unplugged channels 226, the thermal barrier remains sufficient, for example, when as much as 15% of the channels 112 within the region of the thermal barrier channels 224 are unplugged channels 226, the thermal barrier is sufficient, or even when as much as 20% of the channels 112 within the region of the thermal barrier channels 224 are unplugged channels 226, the thermal barrier is sufficient. Thus, while the thermal barrier extends around the entire periphery, the thermal barrier may comprise a percentage of unplugged channels 226.

The honeycomb body 100 disposed in the housing 120 without a mat, in which outer channels of the honeycomb body 100 are plugged 220 around the entire periphery to provide a thermal barrier 224 between the honeycomb body 100 and the housing 120 form an exhaust gas treatment article 230 according to exemplary embodiments of the disclosure. As illustrated in FIGS. 2A and 2B the honeycomb body outer peripheral surface 118 is in direct contact with an inner surface of the housing 120, such as an inner surface of the axial section 122.

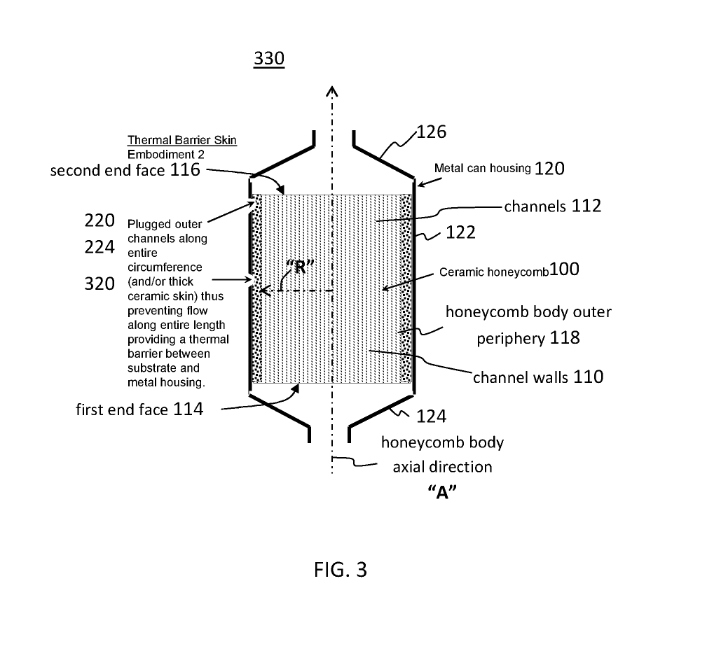

Instead of the outer 20 channels 112 of the honeycomb body 100 at the outer periphery 118 being plugged to form a thermal barrier, a thick ceramic skin 320 can be disposed on the honeycomb body outer periphery 118 to provide a thermal barrier between the honeycomb body 100 and the housing 120. The thick ceramic skin 320 can be disposed around the entire periphery 118 and along the entire periphery 118 from the first end face 114 to the second end face 116. The thick ceramic skin can be porous, and have, for example, a porosity (% P) of greater than 50%. FIG. 3 presents a schematic cross sectional view of a honeycomb body 100 disposed in a housing 120 without a mat, in which a skin 320 of the honeycomb body 100 around the entire periphery 118 provides a thermal barrier between the honeycomb body 100 and the housing 120 according to exemplary embodiments of the disclosure. The thick ceramic skin 320 can be a thickness in a range from 2 micron to 5 mm. Further, the outer channels 112 of the honeycomb body 100 at the outer periphery 118 can be plugged to define thermal barrier channels 224 and a thick ceramic skin 320 can be disposed on the entire honeycomb body outer periphery 118 to provide a thermal barrier between the honeycomb body 100 and the housing 120.

According to these exemplary embodiments the thermal barrier can comprise a thickness greater than 0.2 cm. For example, the thermal barrier can comprise a thickness greater than, 0.5 cm, greater than 0.7 cm, greater than 1 cm or even greater than 2 cm. For example, the thermal barrier can be from about 0.2 cm to about 2.5 cm thick, 0.3 cm to 2.0 cm thick, or about 0.5 cm to about 1.7 cm thick.

The honeycomb body 100 disposed in the housing 120 without a mat, in which the thick ceramic skin 320 is disposed on the entire honeycomb body outer periphery 118 to provide a thermal barrier between the honeycomb body 100 and the housing 120 or the outer channels 112 of the honeycomb body 100 at the outer periphery 118 are plugged and a thick ceramic skin 320 is disposed on the entire honeycomb body outer periphery 118 to provide a thermal barrier between the honeycomb body 100 and the housing 120 form an exhaust gas treatment article 330 according to exemplary embodiments of the disclosure. As illustrated in FIG. 3 the honeycomb body outer peripheral surface 118 is in direct contact with an inner surface of the housing 120, such as an inner surface of the axial section 122. For example, the thick ceramic skin 320 can be in direct contact with an inner surface of the housing 120.

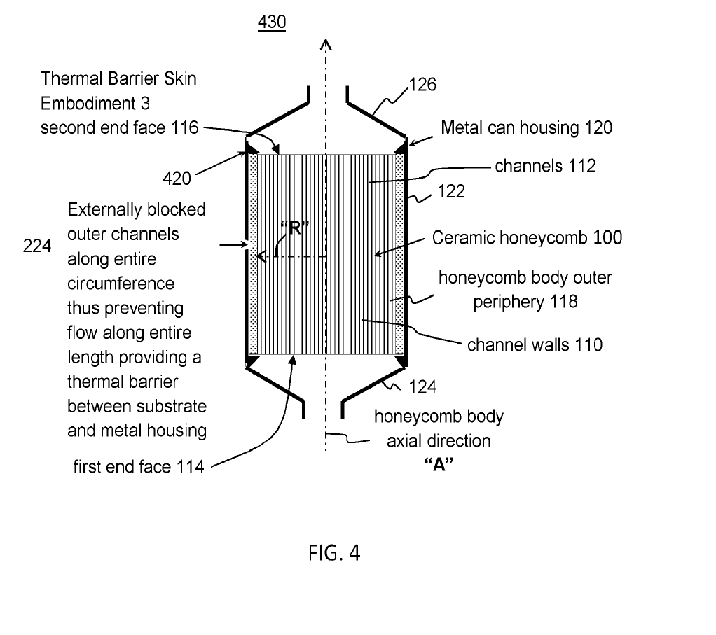

FIG. 4 presents a schematic cross sectional view of a honeycomb body disposed in a housing without a mat, in which a housing component blocks channels of the honeycomb body around the entire periphery to provide a thermal barrier between the honeycomb body and the housing according to exemplary embodiments of the disclosure. The housing can comprise a ring 420 on an inside wall of the housing having a shape to cover outer periphery channels 112 of the honeycomb body 100 adjacent the outer periphery 118. The housing ring 420 blocks exhaust flow to the outer periphery channels to define thermal barrier channels 224. Thermal barrier channels 224 can include channels and partial channels at the honeycomb body outer periphery 118 and channels adjacent thereto extending from two to 30 channels inward along a radial direction toward the center region of the honeycomb body 100. For example, the outer 20 channels 112 of the honeycomb body 100 at the outer periphery 118 can be thermal barrier channels 224, the outer 10 channels 112 of the honeycomb body 100 at the outer periphery 118 can be thermal barrier channels 224, the outer 4 channels 112 of the honeycomb body 100 at the outer periphery 118 can be thermal barrier channels 224, or even the outer 2 channels 112 of the honeycomb body 100 at the outer periphery 118 can be thermal barrier channels 224.

The housing ring 420 can also mount the honeycomb body 100 within the housing 120. For example, the housing ring 420 can provide a compression mounting to the honeycomb body 100 to form an exhaust gas treatment article according to an exemplary embodiment of the disclosure. Accordingly, compression mounting of the honeycomb body 100 in the housing 120 can be achieved by disposing the second end face 116 of the honeycomb body 100 in the housing 120 on a first housing ring 420, heating this assembly to high temperature, for example, to greater than or equal to 400-800° C. above maximum skin temperature that the honeycomb body 100 experiences in exhaust system operation to expand the housing 120, disposing a second housing ring 420 on the first end face 114 of the honeycomb body 100 and on the inside wall of the housing 120, for example, by welding the second housing ring 420 to the inside wall of the housing 120. In these exemplary embodiments, when the metal housing 120 and honeycomb body 100 cool, the honeycomb body 100 will be tightly held by the metal can 120 axial compression to form the exhaust gas treatment article 430. The honeycomb body 100 having a lower coefficient of thermal expansion (CTE), for example, from room temperature (RT) of about 25° C. to 800° C., than the housing 120 CTE provides this shrink fit mounting.

In these exemplary embodiments, when the metal housing 120 and honeycomb body 100 cool, the honeycomb body 100 can be tightly held by the metal can 120 radial compression, as well, when the honeycomb body 100 is disposed in the metal housing 120 after heating the housing 120 to the high temperature to form the exhaust gas treatment article 430 when the housing 120 has an interference fit on the honeycomb body 100 at operating temperatures, for example, between about −40° C. and about 800° C.

Furthermore, when no housing ring 420 is present, in these exemplary embodiments, the metal housing 120 and honeycomb body 100 can be heated to high temperature, for example, to greater than or equal to 400-800° C. above maximum skin temperature that the honeycomb body 100 experiences in exhaust system operation to expand the housing 120, the honeycomb body 100 can be disposed in the metal housing 120, and the assembly cooled to tightly hold the honeycomb body 100 in the metal housing 120 by radial compression and/or axial compression to form the exhaust gas treatment article 430 at all temperatures, for example, between about −40° C. and about 800° C. As illustrated in FIG. 4 the honeycomb body outer peripheral surface 118 is in direct contact with an inner surface of the housing 120, such as an inner surface of the axial section 122. For example, the thick ceramic skin 320 can be in direct contact with an inner surface of the housing 120.

### Examples

Exemplary embodiments of the disclosure are further described below with respect to certain exemplary and specific embodiments thereof, which are illustrative only and not intended to be limiting.

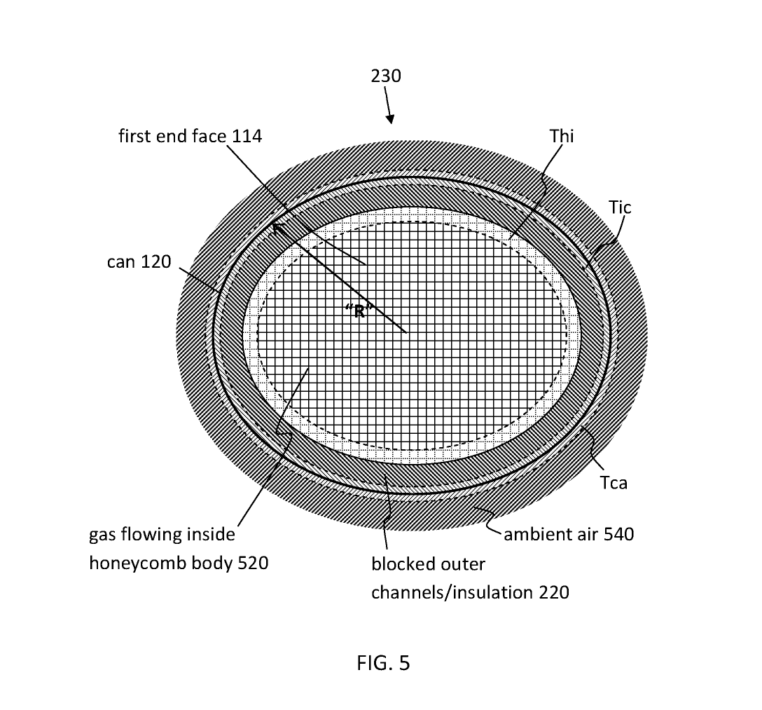

FIG. 5 presents a schematic end view of a honeycomb body 100 disposed in a housing 120 without a mat, in which outer channels 112 of the honeycomb body 100 are plugged around the entire periphery to provide a thermal barrier 220 between the honeycomb body 100 and the housing 120 according to exemplary embodiments of the disclosure. Exhaust gas 520 flowing through the honeycomb body 100 can heat the honeycomb body 100 to a high temperature, for example, the exhaust gas 520 can have a maximum temperature of 300° C., 400° C., 600° C., or even 800° C. The temperature of the exhaust gas at the boundary of the honeycomb body 100 core to the thermal barrier 220 is indicated by Thi. The temperature at the boundary of the thermal barrier 220 to the housing is indicated by Tic. The temperature at the boundary of the housing 120 to the ambient air is indicated by Tca.

In accordance with some of the embodiments, samples are shown in Tables 1-11 detailing the thermal barrier performance of the insulating layer between the honeycomb body 100 core and the metal casing (housing 120) for different thicknesses and thermal conductivities of the insulating layer.

TABLE 1

| Parameter | Example 1 | Example 2 | Example 3 | Example 4 |
|---|---|---|---|---|
| Thickness of Insulating Layer (m) | 0.01 | 0.01 | 0.01 | 0.01 |
| Thermal Conductivity of Insulating Layer (W/m/K) | 0.05 | 0.05 | 0.05 | 0.05 |
| Thickness of Metal Layer (m) | 0.0016 | 0.0016 | 0.0016 | 0.0016 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | Cordierite |
| Total Thickness of Insulating Layer and Metal (m) | 0.0116 | 0.0116 | 0.0116 | 0.0116 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.1524 | 0.1524 | 0.1524 | 0.1524 |
| Diameter of Substrate (m) | 0.1524 | 0.1524 | 0.1524 | 0.1524 |
| Cells per square inch | 600 | 600 | 600 | 600 |
| Wall Thickness, mils | 4 | 4 | 4 | 4 |
| Outside Temp of Metal in Contact with Air (T_{ca}), ° C. | 93 | 129 | 213 | 311 |
| Temp at Insulation-Metal Interface (T_{ic}), ° C. | 93 | 129 | 214 | 312 |
| Temp on Gas Insulation Interface, (Tₕᵢ), ° C. | 246 | 329 | 501 | 677 |

TABLE 2

| Parameter | Example 5 | Example 6 | Example 7 | Example 8 |
|---|---|---|---|---|
| Thickness of Insulating Layer (m) | 0.015 | 0.015 | 0.015 | 0.015 |
| Thermal Conductivity of Insulating Layer (W/m/K) | 0.05 | 0.05 | 0.05 | 0.05 |
| Thickness of Metal Layer (m) | 0.0016 | 0.0016 | 0.0016 | 0.0016 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | Cordierite |
| Total Thickness of Insulating Layer and Metal (m) | 0.0166 | 0.0166 | 0.0166 | 0.0166 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.1524 | 0.1524 | 0.1524 | 0.1524 |
| Diameter of Substrate (m) | 0.1524 | 0.1524 | 0.1524 | 0.1524 |
| Cells per square inch | 600 | 600 | 600 | 600 |
| Wall Thickness, mils | 4 | 4 | 4 | 4 |
| Outside Temp of Metal in Contact with Air (T_{ca}), ° C. | 78 | 107 | 175 | 256 |
| Temp at Insulation-Metal Interface (T_{ic}), ° C. | 78 | 107 | 175 | 257 |
| Temp on Gas Insulation Interface, (Tₕᵢ), ° C. | 257 | 344 | 521 | 701 |

TABLE 3

| Parameter | Example 9 | Example 10 | Example 11 | Example 12 |
|---|---|---|---|---|
| Thickness of Insulating Layer (m) | 0.01 | 0.01 | 0.01 | 0.01 |
| Thermal Conductivity of Insulating Layer (W/m/K) | 0.075 | 0.075 | 0.075 | 0.075 |
| Thickness of Metal Layer (m) | 0.0016 | 0.0016 | 0.0016 | 0.0016 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | Cordierite |
| Total Thickness of Insulating Layer and Metal (m) | 0.0116 | 0.0116 | 0.0116 | 0.0116 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.1524 | 0.1524 | 0.1524 | 0.1524 |
| Diameter of Substrate (m) | 0.1524 | 0.1524 | 0.1524 | 0.1524 |
| Cells per square inch | 600 | 600 | 600 | 600 |
| Wall Thickness, mils | 4 | 4 | 4 | 4 |
| Outside Temp of Metal in Contact with Air (T_{ca}), ° C. | 109 | 152 | 251 | 365 |
| Temp at Insulation-Metal Interface (T_{ic}), ° C. | 109 | 152 | 252 | 365 |
| Temp on Gas Insulation Interface, (Tₕᵢ), ° C. | 233 | 314 | 482 | 655 |

TABLE 4

| Parameter | Example 13 | Example 14 | Example 15 | Example 16 |
|---|---|---|---|---|
| Thickness of Insulating Layer (m) | 0.007 | 0.007 | 0.007 | 0.007 |
| Thermal Conductivity of Insulating Layer (W/m/K) | 0.05 | 0.05 | 0.05 | 0.05 |
| Thickness of Metal Layer (m) | 0.0016 | 0.0016 | 0.0016 | 0.0016 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | Cordierite |
| Total Thickness of Insulating Layer and Metal (m) | 0.0086 | 0.0086 | 0.0086 | 0.0086 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.1524 | 0.1524 | 0.1524 | 0.1524 |
| Diameter of Substrate (m) | 0.1524 | 0.1524 | 0.1524 | 0.1524 |
| Cells per square inch | 600 | 600 | 600 | 600 |
| Wall Thickness, mils | 4 | 4 | 4 | 4 |
| Outside Temp of Metal in Contact with Air (T_{ca}), ° C. | 107 | 149 | 247 | 359 |
| Temp at Insulation-Metal Interface (T_{ic}), ° C. | 107 | 149 | 247 | 359 |
| Temp on Gas Insulation Interface, (Tₕᵢ), ° C. | 235 | 316 | 484 | 657 |

TABLE 5

| Parameter | Example 17 | Example 18 | Example 19 | Example 20 |
|---|---|---|---|---|
| Thickness of Insulating Layer (m) | 0.004 | 0.004 | 0.004 | 0.004 |
| Thermal Conductivity of Insulating Layer (W/m/K) | 0.05 | 0.05 | 0.05 | 0.05 |
| Thickness of Metal Layer (m) | 0.0016 | 0.0016 | 0.0016 | 0.0016 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | Cordierite |
| Total Thickness of Insulating Layer and Metal (m) | 0.0056 | 0.0056 | 0.0056 | 0.0056 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.1524 | 0.1524 | 0.1524 | 0.1524 |
| Diameter of Substrate (m) | 0.1524 | 0.1524 | 0.1524 | 0.1524 |
| Cells per square inch | 600 | 600 | 600 | 600 |
| Wall Thickness, mils | 4 | 4 | 4 | 4 |
| Outside Temp of Metal in Contact with Air (T_{ca}), ° C. | 128 | 179 | 295 | 425 |
| Temp at Insulation-Metal Interface (T_{ic}), ° C. | 128 | 179 | 295 | 425 |
| Temp on Gas Insulation Interface, (Tₕᵢ), ° C. | 219 | 297 | 459 | 629 |

TABLE 6

| Parameter | Example 21 | Example 22 | Example 23 | Example 24 |
|---|---|---|---|---|
| Thickness of Insulating Layer (m) | 0.02 | 0.02 | 0.02 | 0.02 |
| Thermal Conductivity of Insulating Layer (W/m/K) | 0.05 | 0.05 | 0.05 | 0.05 |
| Thickness of Metal Layer (m) | 0.0016 | 0.0016 | 0.0016 | 0.0016 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | Cordierite |
| Total Thickness of Insulating Layer and Metal (m) | 0.0216 | 0.0216 | 0.0216 | 0.0216 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.1524 | 0.1524 | 0.1524 | 0.1524 |
| Diameter of Substrate (m) | 0.1524 | 0.1524 | 0.1524 | 0.1524 |
| Cells per square inch | 600 | 600 | 600 | 600 |
| Wall Thickness, mils | 4 | 4 | 4 | 4 |
| Outside Temp of Metal in Contact with Air (T_{ca}), ° C. | 68 | 92 | 150 | 219 |
| Temp at Insulation-Metal Interface (T_{ic}), ° C. | 68 | 92 | 150 | 219 |
| Temp on Gas Insulation Interface, (Tₕᵢ), ° C. | 265 | 354 | 534 | 717 |

TABLE 7

| Parameter | Example 25 | Example 26 | Example 27 | Example 28 |
|---|---|---|---|---|
| Thickness of Insulating Layer (m) | 0.02 | 0.02 | 0.02 | 0.02 |
| Thermal Conductivity of Insulating Layer (W/m/K) | 0.05 | 0.05 | 0.05 | 0.05 |
| Thickness of Metal Layer (m) | 0.0016 | 0.0016 | 0.0016 | 0.0016 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | Cordierite |
| Total Thickness of Insulating Layer and Metal (m) | 0.0216 | 0.0216 | 0.0216 | 0.0216 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.2794 | 0.2794 | 0.2794 | 0.2794 |
| Diameter of Substrate (m) | 0.2794 | 0.2794 | 0.2794 | 0.2794 |
| Cells per square inch | 200 | 200 | 200 | 200 |
| Wall Thickness, mils | 12 | 12 | 12 | 12 |
| Outside Temp of Metal in Contact with Air (T_{ca}), ° C. | 79 | 108 | 177 | 258 |
| Temp at Insulation-Metal Interface (T_{ic}), ° C. | 79 | 108 | 177 | 259 |
| Temp on Gas Insulation Interface, (Tₕᵢ), ° C. | 257 | 344 | 520 | 700 |

TABLE 8

| Parameter | Example 29 | Example 30 | Example 31 | Example 32 |
|---|---|---|---|---|
| Thickness of Insulating Layer (m) | 0.02 | 0.02 | 0.02 | 0.02 |
| Thermal Conductivity of Insulating Layer (W/m/K) | 0.05 | 0.05 | 0.05 | 0.05 |
| Thickness of Metal Layer (m) | 0.0010 | 0.0010 | 0.0010 | 0.0010 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | Cordierite |
| Total Thickness of Insulating Layer and Metal (m) | 0.021 | 0.021 | 0.021 | 0.021 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.2794 | 0.2794 | 0.2794 | 0.2794 |
| Diameter of Substrate (m) | 0.2794 | 0.2794 | 0.2794 | 0.2794 |
| Cells per square inch | 200 | 200 | 200 | 200 |
| Wall Thickness, mils | 12 | 12 | 12 | 12 |
| Outside Temp of Metal in Contact with Air (T_{ca}), ° C. | 79 | 108 | 177 | 258 |
| Temp at Insulation-Metal Interface (T_{ic}), ° C. | 79 | 108 | 177 | 259 |
| Temp on Gas Insulation Interface, (Tₕᵢ), ° C. | 257 | 344 | 520 | 700 |

TABLE 9

| Parameter | Example 33 | Example 34 | Example 35 | Example 36 |
|---|---|---|---|---|
| Thickness of Insulating Layer (m) | 0.01 | 0.01 | 0.01 | 0.01 |
| Thermal Conductivity of Insulating Layer (W/m/K) | 0.05 | 0.05 | 0.05 | 0.05 |
| Thickness of Metal Layer (m) | 0.0016 | 0.0016 | 0.0016 | 0.0016 |
| Thermal Conductivity of Metal Layer (W/m/K) | 38 | 38 | 38 | 38 |
| Metal type | Carbon Steel | Carbon Steel | Carbon Steel | Carbon Steel |
| Ceramic type | Cordierite | Cordierite | Cordierite | Cordierite |
| Total Thickness of Insulating Layer and Metal (m) | 0.0116 | 0.0116 | 0.0116 | 0.0116 |
| Max Gas Temp [C.] | 300 | 400 | 600 | 800 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.1524 | 0.1524 | 0.1524 | 0.1524 |
| Diameter of Substrate (m) | 0.1524 | 0.1524 | 0.1524 | 0.1524 |
| Cells per square inch | 600 | 600 | 600 | 600 |
| Wall Thickness, mils | 4 | 4 | 4 | 4 |
| Outside Temp of Metal in Contact with Air (T_{ca}), ° C. | 93 | 129 | 213 | 311 |
| Temp at Insulation-Metal Interface (T_{ic}), ° C. | 93 | 129 | 213 | 311 |
| Temp on Gas Insulation Interface, (Tₕᵢ), ° C. | 246 | 329 | 501 | 677 |

TABLE 10

| Parameter | Example 37 | Example 38 | Example 39 | Example 40 |
|---|---|---|---|---|
| Thickness of Insulating Layer (m) | 0.01 | 0.02 | 0.02 | 0.01 |
| Thermal Conductivity of Insulating Layer (W/m/K) | 0.05 | 0.05 | 0.05 | 0.05 |
| Thickness of Metal Layer (m) | 0.0016 | 0.0010 | 0.0010 | 0.0016 |
| Thermal Conductivity of Metal Layer (W/m/K) | 14 | 14 | 14 | 14 |
| Metal type | 409SS | 409SS | 409SS | 409SS |
| Ceramic type | Cordierite | Cordierite | Cordierite | AT |
| Total Thickness of Insulating Layer and Metal (m) | 0.0116 | 0.021 | 0.021 | 0.0116 |
| Max Gas Temp [C.] | 400 | 400 | 800 | 400 |
| Air Temp on Outside [C.] | 23 | 23 | 23 | 23 |
| Velocity at the maximum temperature (m/s) | 10 | 10 | 10 | 10 |
| Velocity of air on outside (m/s) | 5 | 5 | 5 | 5 |
| Length of Substrate (m) | 0.1524 | 0.2794 | 0.2794 | 0.1524 |
| Diameter of Substrate (m) | 0.1524 | 0.2794 | 0.2794 | 0.1524 |
| Cells per square inch | 900 | 300 | 300 | 900 |
| Wall Thickness, mils | 2 | 8 | 8 | 2 |
| Outside Temp of Metal in Contact with Air (T_{ca}), ° C. | 129 | 108 | 258 | 129 |
| Temp at Insulation-Metal Interface (T_{ic}), ° C. | 129 | 108 | 259 | 129 |
| Temp on Gas Insulation Interface, (Tₕᵢ), ° C. | 329 | 344 | 700 | 329 |

TABLE 11

| Parameter | Example 41 | Example 42 | Example 43 | Example 44 | Example 45 |
|---|---|---|---|---|---|
| Thickness of Insulating Layer (m) | 0.02 | 0.02 | 0.01 | 0.02 | 0.02 |
| Thermal Conductivity of Insulating Layer (W/m/K) | 0.05 | 0.05 | 0.05 | 0.05 | 0.05 |
| Thickness of Metal Layer (m) | 0.0010 | 0.0010 | 0.0016 | 0.0010 | 0.0010 |
| Thermal Conductivity of Metal Layer (W/m/K) | 14 | 14 | 14 | 14 | 14 |
| Metal type | 409SS | 409SS | 409SS | 409SS | 409SS |
| Ceramic type | AT | AT | SiC | SiC | SiC |
| Total Thickness of Insulating Layer and Metal (m) | 0.021 | 0.021 | 0.0116 | 0.021 | 0.021 |
| Max Gas Temp [C.] | 400 | 800 | 600 | 400 | 800 |
| Air Temp on Outside [C.] | 23 | 23 | 23 | 23 | 23 |
| Velocity at the maximum temperature (m/s) | 10 | 10 | 10 | 10 | 10 |
| Velocity of air on outside (m/s) | 5 | 5 | 5 | 5 | 5 |
| Length of Substrate (m) | 0.2794 | 0.2794 | 0.1524 | 0.2794 | 0.2794 |
| Diameter of Substrate (m) | 0.2794 | 0.2794 | 0.1524 | 0.2794 | 0.2794 |
| Cells per square inch | 300 | 300 | 300 | 300 | 300 |
| Wall Thickness, mils | 8 | 8 | 8 | 8 | 8 |
| Outside Temp of Metal in Contact with Air (T_{ca}), ° C. | 108 | 258 | 213 | 108 | 258 |
| Temp at Insulation-Metal Interface (T_{ic}), ° C. | 108 | 259 | 214 | 108 | 259 |
| Temp on Gas Insulation Interface, (Tₕᵢ), ° C. | 344 | 700 | 501 | 344 | 700 |

In these Examples, the ceramic bodies are in direct contact with the inner surface of the housing (metal layer). As is clear from Tables 1-11 the temperature of the metal in contact with air is less than 400° C., less than 300° C., even less than 250° C. because of the thermal barrier with no mat for the ceramic body and housing materials tested, and for thermal barrier thicknesses between 0.7 cm to 2 cm. The maximum exhaust gas temperature ranged from 300° C. to 800° C. It was surprising and unexpected to obtain such a good barrier to thermal insulation without a mat between the ceramic bodies as indicated by the temperature of the metal layer in contact with air of less than 400° C., less than 300° C., even less than 250° C. for the ceramic body and housing materials tested, and for thermal barrier thicknesses between 0.7 cm to 2 cm.

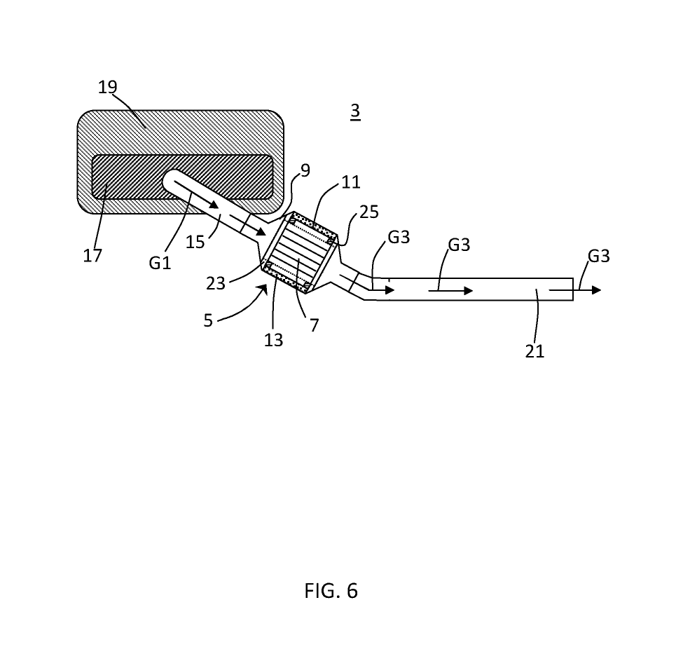

FIG. 6 presents a schematic of an exhaust system 3 comprising an exhaust treatment article 5 comprising a honeycomb body 7 disposed in a housing 9 without a mat, wherein the outer channels 11 of the honeycomb body 7 are blocked around the entire periphery and/or a thermal barrier skin 13 is disposed on the honeycomb body 7 around the entire periphery thereby providing a thermal barrier between the honeycomb body 7 and the housing 9 according to exemplary embodiments of the disclosure. The exhaust system 3 comprises an inlet 15 configured to accept an exhaust gas stream G1 to be purified, for example, from a manifold 17 of an engine 19. The exhaust system 3 comprises the exhaust gas treatment article 5 configured to flow the exhaust gas stream G1 through a honeycomb body 7 to purify the exhaust gas stream G1, and an outlet 21 configured to emit the purified exhaust gas stream G3. The exhaust gas treatment article 5 comprises the porous ceramic honeycomb body 7 and a housing 9 configured to mount the porous ceramic honeycomb body 7. The porous ceramic honeycomb body 7 comprises a plurality of channel walls extending axially from opposing first and second end faces defining cell channels therebetween, an outer peripheral surface extending axially, and a thermal barrier disposed at the outer peripheral surface. The thermal barrier can be comprised of at least one of peripheral channels plugged at the inlet face or the inlet face and the outlet face by housing hardware 23, such as a mounting ring, and/or plug cement 25, around the entire periphery and a skin 13 of the honeycomb body disposed around the entire periphery according to exemplary embodiments of the disclosure.

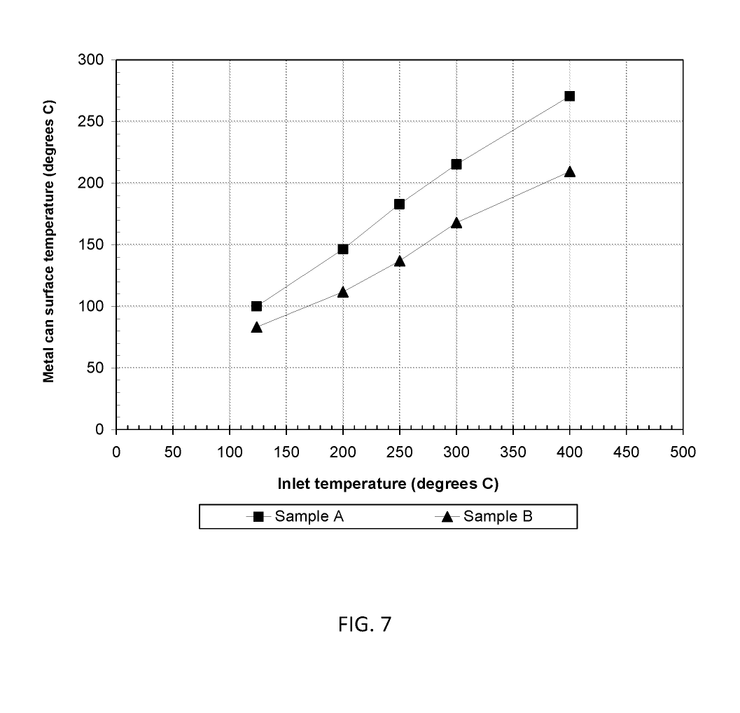

Two cordierite ceramic honeycomb substrates 5.66 inches (14.4 cm) in diameter and 6 inches (15.2 cm) in length having cell density of 300 cells per square inch (46.5 cells per square cm) and wall thickness of 5 mils (127 microns) were mounted in metal housings with different configurations. Each of the samples had an outer ceramic skin layer comprising cordierite and having thickness of about 2 mm. The first honeycomb substrate, Sample A, was canned in a stainless steel metal housing with the metal housing in direct contact with the honeycomb substrate skin layer. No full channels in substrate Sample A were plugged, however some partial channels may be plugged by the ceramic skin layer. The second honeycomb, Sample B, was canned in a metal housing with the metal housing in direct contact with the honeycomb substrate 2 mm thick skin layer and where the peripheral outer four channels (corresponding to about 6 mm total width of channels) were plugged with ceramic at both the inlet and outlet ends. The samples had stainless steel flanges attached to each end and were tested on a burner rig, where they were exposed to exhaust gas at gas temperatures ranging between 125° C. and 400° C., with the gas flow rate of about 145 standard cubic feet per minute (SCFM). The temperature of the metal housing was measured on the outside of the can and about 2 cm below the gas inlet to the honeycomb substrate. The results are shown in FIG. 7. The metal housing temperature for Sample B having peripheral channels plugged was measured to be significantly lower (about 50-200° C.) than gas inlet temperatures with the inlet temperature range of 125-400° C. In addition, the metal housing temperature for Sample B having peripheral channels plugged was measured to be significantly lower (about 20-60° C.) than the metal housing temperature of Sample A which had no full peripheral channels plugged.

According to exemplary embodiments of the disclosure, a honeycomb body comprising a thermal barrier, a low cost exhaust gas treatment article comprising the same, an exhaust system comprising the exhaust gas treatment article, and a method to produce the same is provided. In some embodiments, the exhaust gas treatment article and canning method to produce the same eliminates or minimizes the need for mats. Moreover, the exhaust gas treatment article avoids potential problems of the mat decomposing and fibers from the mat plugging downstream parts of an emission (exhaust) system. Another advantage of the low cost exhaust gas treatment article and canning method to produce the same according to exemplary embodiments of the disclosure is providing heat shielding of the honeycomb body from the housing achieved by blocking the outer cells of the honeycomb body via the housing mounting ring and/or plug cement at the outer area of the honeycomb. Another advantage of the low cost exhaust gas treatment article and canning method to produce the same according to exemplary embodiments of the disclosure is providing heat shielding of the honeycomb body from the housing achieved by blocking the outer cells of the honeycomb body and/or by a thermal barrier skin 13 of the honeycomb body disposed around the entire periphery of the honeycomb body.

It will be apparent to those skilled in the art that various modifications and variations can be made in the present disclosure without departing from the spirit or scope of the disclosure. Thus, it is intended that the appended claims cover the modifications and variations of this disclosure provided they come within the scope of the appended claims and their equivalents.

1. An exhaust gas treatment article, comprising:
a honeycomb body, comprising:
a porous ceramic and having a plurality of channel walls extending axially from opposing first and second end faces defining cell channels therebetween, and an outer peripheral surface extending axially, and
a thermal barrier disposed at the outer peripheral surface, wherein the thermal barrier comprises at least one of:
blocked peripheral cell channels adjacent to and around the peripheral surface and
a thermal barrier skin; and
a housing configured to mount the honeycomb body,
wherein an inner surface of the housing is in direct contact with the honeycomb body.

2. The article of claim 1, wherein the housing comprises rings disposed on the inner surface at the opposing first and second end faces of the honeycomb body to block the peripheral cell channels adjacent to and around the entire peripheral surface.

3. The article of claim 2, wherein the housing is disposed on the honeycomb body by an axial compression between the rings disposed on the inner surface at the opposing first and second end faces of the honeycomb body in a temperature range of −47° C. to 800° C., wherein the honeycomb body has a coefficient of thermal expansion (CTE) (RT-800° C.) of less than the housing CTE (RT-800° C.).

4. The article of claim 1, wherein the thermal barrier further comprises plugs disposed in the peripheral cell channels adjacent to and around the entire peripheral surface.

5. The article of claim 4, wherein the plugs are disposed in the peripheral cell channels adjacent to and around the entire peripheral surface at both the first and second end faces.

6. (canceled)

7. (canceled)

8. The article of claim 1, wherein the thermal barrier comprises a thickness greater than 0.5 cm.

9. The article of claim 1, wherein the thermal barrier comprises a thickness greater than 1 cm.

10. The article of claim 1, wherein the thermal barrier comprises a thickness greater than 2 cm.

11. The article of claim 1, wherein no mat is disposed between the honeycomb body and the housing.

12. The article of claim 1, wherein the housing comprises at least one of steel and stainless steel.

13. The article of claim 1, wherein the housing comprises at least one of 300 series stainless steel and 400 series stainless steel.

14. The article of claim 1, wherein the housing is disposed on the honeycomb body by an interference fit in a temperature range of −47° C. to 800° C., wherein the honeycomb body has a coefficient of thermal expansion (CTE) (RT-800° C.) of less than the housing CTE (RT-800° C.).

15. The article of claim 1, wherein the blocked peripheral cell channels adjacent to and around the peripheral surface comprise at least 10% unblocked channels

16. The article of claim 15, wherein the blocked peripheral cell channels adjacent to and around the peripheral surface comprise at least 15% blocked channels.

17. The article of claim 15, wherein the blocked peripheral cell channels adjacent to and around the peripheral surface comprise at least 20% blocked channels.

18. An exhaust system, comprising:
an inlet configured to accept an exhaust gas stream to be purified;
an exhaust gas treatment article configured to flow the exhaust gas stream through a honeycomb body to purify the exhaust gas stream; and
an outlet configured to emit the purified exhaust gas stream,
wherein the exhaust gas treatment article comprises:
a honeycomb body, comprising:
a porous ceramic and having a plurality of channel walls extending axially from opposing first and second end faces defining cell channels therebetween, and an outer peripheral surface extending axially, and
a thermal barrier disposed at the outer peripheral surface, wherein the thermal barrier comprises at least one of:
blocked peripheral cell channels adjacent to and around the peripheral surface and
a thermal barrier skin; and
a housing configured to mount the porous ceramic honeycomb body,
wherein an inner surface of the housing is in direct contact with the honeycomb body.

19. A method of manufacturing an exhaust gas treatment article, comprising:
mounting a honeycomb body in a housing, the honeycomb body comprising a porous ceramic and having a plurality of channel walls extending axially from opposing first and second end faces defining cell channels therebetween, and an outer peripheral surface extending axially, the housing configured to hold the honeycomb body in an exhaust gas stream, the mounting comprising:
disposing the honeycomb body in an inner space defined by an inner surface of the housing,
wherein the honeycomb body comprises a thermal barrier disposed at the outer peripheral surface, wherein the thermal barrier comprises at least one of blocked peripheral cell channels adjacent to and around the peripheral surface and a thermal barrier skin, and
wherein the inner surface of the housing is in direct contact with the honeycomb body.

20. The method of claim 19, further comprising heating the housing to a temperature 400-800° C. above a maximum skin temperature that the honeycomb body experiences in exhaust system operation to expand the housing;
disposing the honeycomb body in the inner space at the heated temperature; and
cooling to shrink the housing.

21. The method of claim 20, wherein the cooling the housing applies at least one of a radial and axial compressive force to the honeycomb body at temperatures between about −40° C. and about 800° C.

22. (canceled)

23. The method of claim 20, wherein first and second housing rings are disposed on the honeycomb body and configured to block exhaust gas flow peripheral to cell channels adjacent to and around the entire outer peripheral surface of the honeycomb body.
